(19) United States
(12) Patent Application Publication
(10) Pub. No.: US 2003/0081654 A1
(43) Pub. Date: May 1, 2003

(54) Dynamic frequency-hopping system

(76) Inventors: Todor Cooklev, Salt Lake City, UT (US); W. Kurt Dobson, Sandy, UT (US); Dirk Ostermiller, Salt Lake City, UT (US); Sy Prestwich, West Jordan, UT (US)

Correspondence Address: NIXON PEABODY, LLP, 8180 GREENSBORO DRIVE, SUITE 800, MCLEAN, VA, 22102, US

(21) Appl. No.: 09/755,190

(22) Filed: Jan. 8, 2001

Related U.S. Application Data
(60) Provisional application No. 60/175,449, filed on Jan. 8, 2000.

(51) Int. Cl. H04K 1/00

(52) U.S. Cl. 375/132

(57) ABSTRACT

A frequency-hopping system is disclosed, in which the band for frequency hopping is dynamically changed in response to changing channel conditions or a command. Simultaneously with the change of the band of operation the output power may be changed as well, so that the system satisfies at all times the regulatory requirements of the country it operates in.

### BACKGROUND OF THE INVENTION

1. Field of the Invention

This invention relates generally to wireless communication systems utilizing frequency hopping.

2. Description of Related Art

The major advantage of wireless communication devices is that they do not require wires. The disadvantage is that, well, they do not require wires and operate generally in the same frequency band. Thus clearly spectrum is the single most precious resource in wireless communications. In 1985 the Industrial, Scientific and Medical bands (three unlicensed bands 902-928 MHz, 2.4-2.4835 GHz, and 5.725-5.870 GHz) were allotted by the FCC for general-purpose communications under part 15 regulations. Thousands of ISM devices are now available on the market. Since the spectrum is unlicensed, thousands of other wireless applications are yet to come. For example, recently a wireless standard called Bluetooth was promulgated. The Bluetooth standard is available at www.bluetooth.com and is incorporated here as a reference in its entirety. Recently the Unlicensed National Information Infrastructure (U-NII) bands, three unlicensed bands in the 5 GHz region, have also received a lot of attention, as they promise high data rates. Frequency hopping systems are currently the most popular and a lot of work has been done in frequency-hopping systems.

U.S. Pat. No. 5,832,026, assigned to Motorola, Inc, of Schaumburg, Ill., and incorporated here as a reference in its entirety, describes a sophisticated FH system which is more robust against jammers. However, the complexity of the approach is prohibitive for high-volume consumer applications.

Other relevant prior art is described in U.S. Pat. No. 5,862,142, assigned to Hitachi, Ltd, of Tokyo, Japan, and incorporated here as a reference in its entirety. This patent describes an arrangement for a frequency-hopping wireless local area network (WLAN) where there is a controller base station which controls the carrier frequency hop timing of the other base stations. This is convenient for some frequency-hopping WLANs, but does not solve the fundamental problem of coexistence.

A system, where at least one transceiver searches for a set of usable frequencies and communicates this set to the other transceivers on the network, and employs frequency-hopping in this set of frequencies is disclosed in U.S. Pat. No. 5,214,788, assigned to Thomson-CSF of Puteaux, France, and incorporated here as a reference in its entirety.

A frequency-hopping communication method where the hopping frequencies change as a result of counted number of errors is disclosed in U.S. Pat. No. 5,541,954 assigned to Sanyo Electric Co., of Osaka, Japan, and incorporated here as a reference in its entirety. In this patent the errors on all the hopping frequencies are counted and, if the errors on a given frequency exceed a certain threshold, the frequency is not used.

U.S. Pat. No. 5,657,343, assigned to InterDigital Technology Corp., of Wilmington, Del., discloses a system, where the system bandwidth B is divided into N non-overlapping sets of frequencies. Each of the base stations has a coverage area divided into a plurality of N concentric regions, with each concentric region assigned one of the N sets of frequencies.

U.S. Pat. No. 5,870,391, assigned to Canon, of Tokyo, Japan, discloses a FH system, where a controller is used, and instead of using a distinct frequency for communication to each of the devices, the controller uses a common FH pattern for the communication of control information.

While multiple-access methods have been thoroughly investigated in the prior art, nowhere in the prior art it is considered that there may be several wireless systems operating in the same frequency band. Multiple-access methods consider how multiple devices (or users) can use the spectrum according to the same protocol. They do not and cannot consider how different wireless systems can coexist in the same frequency band. Every wireless system assumes that it has the entire spectrum available to itself. This is a truly deplorable situation that—if no measures are taken—ultimately can adversely impact all standards for wireless communications and threaten the user acceptance of wireless technology. For example, as the number of these wireless devices grows, the lack of coexistence can discourage consumers to use more wireless devices. This is especially important in home networking applications, where the number of wireless devices is expected to skyrocket in the next several years. Devices that transmit relatively at a higher power will get their data through. The other devices will not. We call this the “big stick” policy. Devices that have a bigger stick will work.

One way to try to “solve” the problems of coexistence and interoperability is influenced by some scientific modeling of wireless personal area network (WPAN) and WLAN devices installed in typical home and office spaces, etc., and is based on assumptions that the different systems are less likely to be used simultaneously. This does nothing to solve the coexistence problem, and is, furthermore, wrong in home networking applications, where all systems are likely to be used at the same time.

Thus, the “big stick” policy needs to be replaced with the “good citizen” policy. And what is needed is a method and apparatus according to which a FH system can dynamically adjust the band it occupies, so that it can coexist with other different wireless systems in the same band.

### SUMMARY OF THE INVENTION

It is an object of the present invention to disclose an improved frequency-hopping system, that can dynamically change the bandwidth it occupies.

It is another object of the present invention to disclose a frequency-hopping system that can change the bandwidth it occupies in response to changing channel conditions or commands.

It is yet another object of the present invention to disclose a frequency-hopping system that, in changing the bandwidth it occupies, is able to adjust its output power level.

It is yet another object of the present invention to disclose a FH system, which does not subscribe to the above-mentioned “big stick” policy, but follows a “good citizen” policy, where it dynamically adjusts its parameters to accommodate other wireless systems, which may or may not be frequency hopping.

### BRIEF DESCRIPTION OF THE DRAWINGS

FIG. 1 illustrates the operation of an exemplary frequency hopping systems.

### DETAILED DESCRIPTION OF THE INVENTION

To be specific, we'll consider the operation of a frequency-hopping system in the 2.4 GHz ISM band. The operation in any band would be substantially similar. The 2.4 GHz ISM band is 83.5 MHz wide, between 2.4 and 2.4835 GHz, everywhere except in Spain, France, and Japan. (Here we describe the operation in the USA and Europe, a substantially similar method of operation can be constructed for Spain, France and Japan).

In time instant t1 only a 1 MHz-wide band around f1 is used. In the next time instant t2, another 1 MHz-wide band is used, centered around another frequency. The hopping is performed according to a pseudo-random sequence, known only to the transmitter and the intended receiver. In the case of the Bluetooth system, the hopping sequence is derived from the device address of the master of the connection. The master of the connection is the device that temporarily controls the communication, all devices are physically the same and are able to assume the role of masters. Since the hopping sequence is not known to other receivers, hopping is considered secure. Furthermore, if one of the narrowband 1 MHz-wide channels is jammed, for example fl, the next channel is very likely to be good. The disadvantage of frequency hopping is that a signal, that needs only 1 MHz for transmission is spread over the entire 80 MHz-wide band. This is not only wasteful of bandwidth, but essentially does not allow the operation of other wireless systems in the same ISM band. For example, for the Bluetooth standard, taking into account the guard bands, there are 79 possible hopping channels, each of width 1 MHz. These channels are 2402+K MHz, K=0, . . . , 78.

The operation of the system according to the first embodiment of the present invention is as follows. The master of the connection monitors the signal-to-noise ratio in all channels. Then it finds a channel that has the highest signal-to-noise ratio and communicates this to the other devices. Further communication takes place on the selected channel without frequency hopping to other channels. Should the signal-to-noise ration on this channel deteriorate gradually or suddenly to the point it can no longer be used for reliable communication, the frequency hopping within the entire band is restored by the master issuing a command to the slaves. Then, another attempt is made to find a single channel that can be reliably used for communication. In this system frequency hopping is used only during establishment of a connection, or when a change in the frequency channel needs to be implemented. At all other times frequency hopping is not performed.

When frequency hopping is not performed the output power must satisfy certain requirements. In the United States the Industrial, Scientific and Medical (ISM) bands are governed by FCC Part 15.247 (Spread Spectrum) and 15.249 (lower ERP). The relevant FCC regulations are given in Table 1. If spread-spectrum is not used the output power is limited to 50 mV/m at 3 m. This output power is sufficient for applications like wireless personal area networking (WPAN), wireless home networking, etc., which normally require reliable communication over distances of about 30 feet.

TABLE 1
Output power limitations for non-spread and
spread wireless devices in the ISM bands.

| | Frequency | | |
|---|---|---|---|
| | 902-928 MHz | 2.4-2.4835 GHz | 5.725-5.875 GHz |
| Field strength of | 50 mV/m at 3 m | 50 mV/m at 3 m | 50 mV/m at 3 m |
| fundamental (lower ERP | (−1.25 dBm Tx | (−1.25 dBm Tx | (−1.25 dBm Tx |
| non-spread) | power for 0 dBi | power for 0 dBi | power for 0 dBi |
| | antenna) | antenna) | antenna) |
| Peak transmit power (spread, | 1 W | 1 W | 1 W |
| up to +6 dBi antenna) | | | |

The U-NII bands are governed in the U.S. by FCC Part 15.401 through 15.407 and the regulations are given in Table 2 and non-spread operation in these bands is also possible. Also, while here we are mainly concerned with regulations in the United States, similar regulations exist in the other countries. Thus the applicability of the present invention is not limited to the United States, and the implementation of a system according to this embodiment would be substantially similar everywhere in the world.

TABLE 2
Output power regulations in the U-NII bands.

| | Frequency | | |
|---|---|---|---|
| | 5.15-5.25 GHz | 5.25-5.35 GHz | 5.725-5.825 GHz |
| Use | Indoor use only; | Indoor or | Primarily |
| | integral antenna | outdoor use | outdoor use |
| Power (Where B = −26 dB | 50mW or 4 dBm + | 250 mW or 11 dBm + | 1 W or 17 dBm + |
| bandwidth in MHz) | 10 logB | 10 logB | 10 logB |
| Power spectral density | 4 dBm in a 1 | 11 dBm in a 1 | 17 dBm in a 1 |
| (max.) Antenna gain up to 6 | MHz band | MHz band | MHz band |
| dBi | | | |

It is plain to observe that the first embodiment of the present invention has a number of advantages. First, a 1 MHz signal is transmitted only on one 1 MHz-wide channel, thus the implementation is spectrally very efficient. Second, and much more importantly, the other channels can be used by other wireless systems, which may or may not be frequency-hopping. For example, some of the other wireless systems can be high-rate orthogonal frequency-division multiplexing (OFDM) systems. Third, the proposed here solution is the simplest and most economical way to achieve coexistence among wireless communication systems. While sophisticated error-correcting coding and equalization may improve the performance of all wireless systems, even when they face the “big stick” policy, the complexity and cost would be significant and perhaps prohibitive in high-volume applications. Finally, the proposed here implementation replaces the “big stick” policy with the “good citizen” policy.

In the second embodiment of the present invention, instead of eliminating hopping entirely, the devices can hop in a narrower band. For example, in the 2.4 GHz ISM band, instead of hopping on 79 channels for 2402+K MHz, where K is the set of {0, . . . , 78}, the invention can be implemented by restricting the value of the integer K to a closed subset of the set {0, . . . , 78}. The rest of the band is made available for other wireless systems. This also achieves the objectives of the present invention, and—since frequency hopping continues to be employed albeit in a narrower band—the devices can transmit typically at a higher power than non-spread devices, according to the appropriate regulations. According to the second embodiment, a wireless transceiver, e.g. the master of the connection will determine which subband of the entire band to use, on the basis of the vacant portion of the spectrum. For example, if there is another wireless system in operation in the same band, which is also a “good citizen”, most of the channels will offer a high signal-to-noise ratio. The transceiver can select those that offer the highest signal-to-noise ratio. Another instance of the second embodiment is where the transceiver selects a number of channels, depending on the requirements for the particular application. Thus a higher data rate can be obtained. The operation of the wireless system according to this second embodiment is dynamic, and if the conditions on the selected channels deteriorate, e.g. the signal-to-noise ratio decreases, the system returns to hopping in the entire band, and selects another set of good channels. Alternatively, the system may select a new set of channels without returning to hopping in the entire band. This can happen, for example, if conditions have deteriorated on only some of the channels, such that other channels still offer acceptable signal-to-noise ratio. The master of the connection can communicate the new set of channels to the other transceivers using only the available good channels. Another part of the second embodiment is that when there is a change in the number of channels used power may be adjusted to levels allowed by the appropriate regulatory agencies, if necessary.

One implementation of the second embodiment can be easily devised in the important special case of Bluetooth. This standard supports different number of hop frequencies according to the country of operation. There are four special cases: France, Spain, Japan, and the rest of the world, including USA. Japan, for example, has only 23 MHz available in this ISM band. Thus the hop frequencies for Japan are already a closed subset of the set {0, . . . , 78}. Thus Bluetooth devices have a built-in capability to hop on four different set of channels. This can facilitate the implementation, at least for the US and the rest of the world, of the second embodiment of the present invention.

In some cases, where a plurality of wireless systems operate in the same band (not an uncommon situation in future home networking) it may be impossible for a single transceiver to determine the channel or set of channels that can be reliably used for communication. In these instances, the devices will be managed by a wireless hub or a spectrum-managing controller. By using methods not discussed here, this spectrum-managing controller will find a suitable channel or a set of channels and will communicate them to the devices. Thus the spectrum-managing controller will dynamically monitor and manage the frequency band of interest.

The present invention may be embodied in other specific forms without departing from its spirit of essential characteristics. The described embodiments are to be considered only as illustrative and not restrictive. The scope of the invention, is, therefore, indicated by the appended claims rather than by the foregoing description. All changes which come within the meaning and range of equivalency of the claims are to be embraced within their scope.

1. A wireless system operating in accordance with a defined frequency hopping protocol within a defined frequency band or bands and capable of co-existing with at least one other independent wireless system operating within the defined frequency band or bands, comprising
a transmitter for operating in accordance with the defined frequency hopping protocol, said transmitter being dynamically adjustable, in response to a control signal, to restrict operations in accordance with the defined frequency hopping protocol to a sub-set of frequencies within the defined frequency band or bands, said transmitter including a control signal generator for generating said control signal to control dynamically the subset of frequencies within said defined frequency band or bands within which said transmitter operates in response to changing conditions or commands to allow said system to operate in coexistence with the other system that is operating simultaneously within the defined frequency band or bands.

2. The wireless system as recited in claim 1, wherein said transmitter operates on a subset consisting of only one frequency subband.

3. The wireless system as recited in claim 1, wherein said control signal generator operates by monitoring said plurality of bands and generating said control signal to cause said transmitter to operate over one or more subbands out of said plurality of bands.

4. The wireless system as recited in claim 1, wherein said control signal generator operates by measuring the power level in said plurality of bands and by generating said control signal to cause said transmitter to operate over the subband that has been measured to have the lowest power level.

5. The wireless system as recited in claim 1, wherein said transmitter may adjust its power if necessary to fall within regulatory requirements.

6. The wireless system as recited in claim 1, wherein said control signal generator responds to an internally generated command signal.

7. The wireless system as recited in claim 1, wherein said control signal generator responds to an externally generated command signal, said command signal being communicated to said control signal generator through common communications protocols.

8. A wireless system operating in accordance with a defined frequency hopping protocol within a defined frequency band or bands and capable of co-existing with at least one other independent wireless system operating within the defined frequency band or bands, comprising
a receiver for operating in accordance with the defined frequency hopping protocol, said receiver being dynamically adjustable, in response to a control signal, to restrict operations in accordance with the defined frequency hopping protocol to a sub-set of frequencies within the defined frequency band or bands, said receiver including a control signal generator for generating said control signal to control dynamically the subset of frequencies within said defined frequency band or bands within which said receiver operates in response to changing conditions or commands to allow said system to operate in coexistence with the other system that is operating simultaneously within the defined frequency band or bands.

9. The wireless system as recited in claim 8, wherein said receiver operates over a subset of frequencies consisting of only one frequency subband.

10. The wireless system as recited in claim 8, further including a transmitter for wireless communications with said receiver operating in accordance with the defined frequency hopping protocol, said transmitter being dynamically adjustable, in response to a control signal, to restrict operations in accordance with the defined frequency hopping protocol to a sub-set of frequencies within the defined frequency band or bands, said transmitter including another control signal generator for generating said control signal to control dynamically the subset of frequencies within said defined frequency band or bands within which said transmitter operates in response to changing conditions or commands to allow said system to operate in coexistence with the other system that is operating simultaneously within the defined frequency band or bands, and wherein the system includes a plurality of communicating pairs of said transmitters and said receivers.

11. The wireless system as recited in claim 10, wherein said control signal generators and said another control signal generators produce control signals for causing the corresponding said transmitters and receivers to operate in a plurality of bands whose size can be adjusted dynamically to optimize the radio link between each pair of communicating receiver and transmitter or to cause each radio link to meet regulations requirement.

12. The wireless system as recited in claim 11, wherein said transmitters may operate as a receiver and said receivers may operate as a transmitter to form a plurality of transceivers.

13. The wireless system as recited in claim 12, wherein said transceivers operate in accordance with a protocol that allows the rate at which said transceivers hop from one operating frequency to the next to be dynamically adjusted.

14. In a wireless system operating in accordance with a defined frequency hopping protocol within a defined frequency band or bands and capable of co-existing with at least one other independent wireless system operating within the defined frequency band or bands, a method comprising the steps of
providing a transmitter capable of operating in accordance with the defined frequency hopping protocol and capable of being dynamically adjusted in response to a control signal to restrict operations to a changeable sub-set of frequencies within the defined frequency band or bands, and
generating a control signal to control dynamically the subset of frequencies within said defined frequency band or bands within which the transmitter operates in response to changing conditions or commands to allow the system to operate in coexistence with the other system that is operating simultaneously within the defined frequency band or bands.
